(19) United States
(12) Patent Application Publication
(10) Pub. No.: US 2014/0139888 A1
(43) Pub. Date: May 22, 2014

(54) METHOD AND APPARATUS FOR SCANNING LARGE-FORMAT DOCUMENTS

(71) Applicants: Stephan FRISCH, Weitefeld (DE); Simon KAEMPFLEIN, Friedewald (DE); Victor HILDEBRANDT, Kirchen (DE)

(72) Inventors: Stephan FRISCH, Weitefeld (DE); Simon KAEMPFLEIN, Friedewald (DE); Victor HILDEBRANDT, Kirchen (DE)

(21) Appl. No.: 14/166,309

(22) Filed: Jan. 28, 2014

Related U.S. Application Data
(63) Continuation-in-part of application No. 13/203,725, filed on Aug. 27, 2011, now abandoned.

(30) Foreign Application Priority Data
Mar. 10, 2009 (DE) 10 2009 011 945.0

(51) Int. Cl. H04N 1/00

(52) U.S. Cl. CPC H04N 1/00779
USPC 358/406; 358/449

(57) ABSTRACT

A large-format scanner having an imaging element and connected to a PC by a standard interface of predetermined maximum bandwidth is provided with a variable-speed document feeder and with a device upstream of the imaging element for detecting the width transverse to the feed direction of a document being moved through the apparatus by the feeder. As soon as the document width is detected and before the document reaches the imaging element, any sensors of the imaging element that will not confront the document are turned off and the document speed is adjusted so that the sensors left on produce a data output of a bandwidth close to but below the maximum bandwidth of the interface, with wide documents being fed faster than narrow documents.

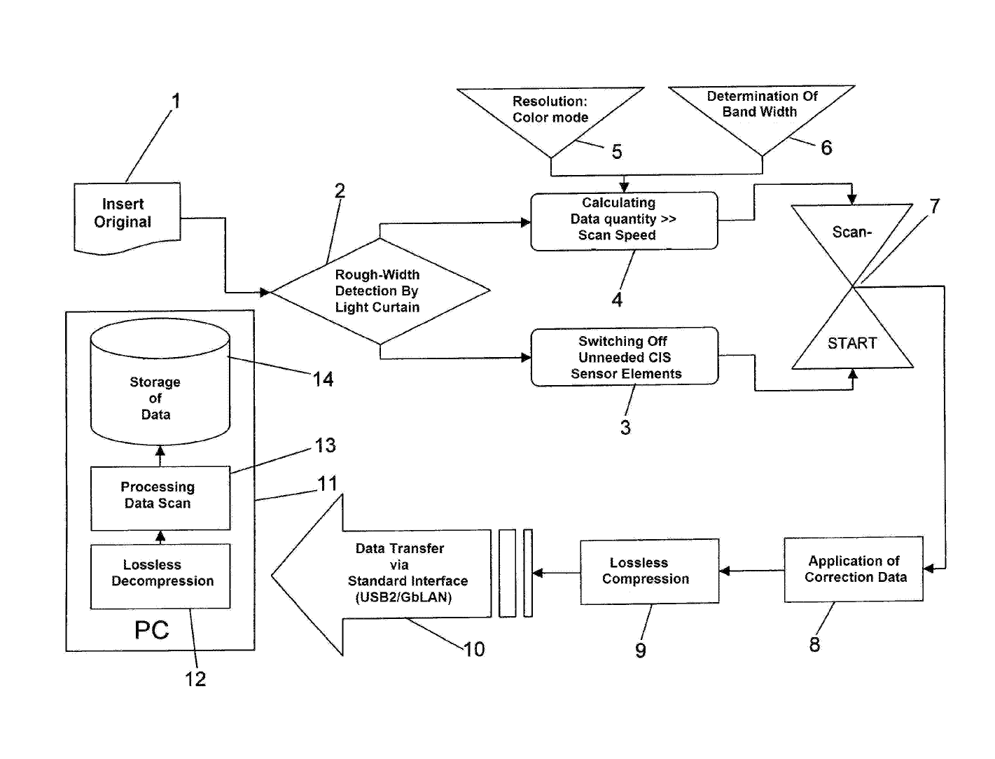

### CROSS REFERENCE TO RELATED APPLICATIONS

This application is a continuation-in-part of U.S. patent application Ser. No. 13/203,725 filed 27 Aug. 2011 as the US-national stage of PCT application PCT/EP2010/001271 filed 2 Mar. 2010, published 16 Sep. 2010 as WO2010/102739, and claiming the priority of German patent application 102009011945.0 itself filed 10 Mar. 2009.

### FIELD OF THE INVENTION

The invention relates to an apparatus and a method of scanning large-format documents with a large-format scanner that is connected to a PC via a standard interface.

### BACKGROUND OF THE INVENTION

Large-format scanners are known that have an integrated is computer that has corresponding input channels according to the number of channels of, for example contact-image sensors or CCD cameras of the large-format scanner. This computer can process all incoming data so quickly that high scanning speeds are possible.

However, for cost reasons, a large-format scanner is often not provided with a complex integrated computer, instead PC's provided on site are to be used for recording and storing the scanned data. It has proven to be a disadvantage here that only a specific data quantity can be transferred via the interface between the large-format scanner and the PC. Since with large-format scanners with large document widths there are correspondingly large quantities of data that have to be transmitted simultaneously, the scanners are run in steps or operated only very slowly during the scan process so that all the data can be transferred without losses. In order to be able to determine the data quantity beforehand, so-called prescans are carried out in the case of such scanners and the speed of the scanner is set depending on the data quantity to be expected as determined by the prescan. The disadvantage with this is that on the one hand time must be taken for the prescan and on the other hand effort must be made to move back the document after the prescan in order to be able to start the actual scan.

US 2009/0040560 discloses a scanning apparatus in which the scanned images are first stored in an internal memory. The stored data can be transferred from the memory to a computer. The scanner unit is stopped or started again depending on the free capacity of the scanner memory. It is furthermore disclosed that, according to U.S. Pat. No. 6,648,226, instead of stopping and starting the document feed again, a speed control for the document feed is possible.

From DE 690 25 751 [5,053,885], document recognition techniques for copier apparatuses are known where the size and the position of the document can be recognized automatically.

JP 63-7076A also discloses a scanner unit with document recognition where avoiding the transfer of unnecessary data and shortening the reading time are achieved by carrying out a restriction to the necessary width and length of the document.

### OBJECT OF THE INVENTION

The object of the invention is to further develop an apparatus and a method of scanning large-format documents such that prescans are eliminated, the scan speed is optimized, a clear increase in productivity is achieved between initial placement of the document and storage of the data in the PC so that cost-effective scans result.

### SUMMARY OF THE INVENTION

In terms of the apparatus, the object is attained in that a device for detecting the width of the document is provided in the document path of the large-format scanner, that the width-detecting device is connected to an electric circuit that in turn is connected to at least one image-capturing element of the large-format scanner, that at least some of the image-capturing elements can be switched off depending on the detected document width, that a device for continuously determining the maximum transmission bandwidth of the standard interface is provided, that the width-detection device is connected to a drive for the documents, and that the speed of the document drive can be adjusted depending on the output signals of the width-detection device.

In other words, the invention is a method of operating a large-format scanner having means for feeding a document along a document feed path in a predetermined longitudinal direction at a feed speed with a width of the document extending transverse to the direction, an image-capturing element comprised of a row extending transversely across the path of image sensors such that a data output of the element has a bandwidth determined by the number of sensors in the row and the feed speed, and a standard interface of predetermined maximum transmission bandwidth connected to the element and connectable to a computer to feed outputs of the sensors of the element to the computer. According to the invention a device is provided in the scanner along the document feed path longitudinally upstream of the image-capturing element and using the device for detecting a width of a document moving along the path, sensors are employed in the element that can be turned on and off individually, and a document-feeding means of variable speed is employed. Thus, on movement of the document in the direction past the device by the document-feeding means, a width transverse to the feed direction of the document is determined. Then, before the document reaches the element and based on the detected width of the document, those sensors of the image-capturing element that will not confront the document are turned of before the document longitudinally passes the image-capturing element. In addition the feed speed of the document as it moves past the element is set such that documents of great width move more slowly past the element than documents of narrow width and the bandwidth of the output is generally equal to the maximum transmission bandwidth of the interface.

It has proven to be advantageous that the device for detecting the width of the document is a photoelectric curtain. Such a photoelectric curtain operates quickly and without contact. It does not impede the scanning process. Of course, microswitches or also side gauges provided with position sensors or the like can also be used as the document-width detector.

It has proven useful thereby that the photoelectric curtain sensors at least on one side of the center of the document path are set at increasingly smaller spacings. The document can be centered by prior adjustment of side gauges or the like. As a result it is not necessary for the photoelectric curtain to extend across the entire width of the scanner. However, the photoelectric curtain can also extend across the entire width of the scanner so that a centering between side gauges can be omitted. Due to the increasing spacings between the photoelectric curtain, in the outer region where the edges of large-format documents are regularly to be found, the format can be determined with higher accuracy than in the center of the document feeder. Of course, it is also conceivable to set the image-capturing elements of the photoelectric curtain at uniform spacings from one another, preferably at spacings that are as small as possible.

It has proven advantageous when the image-capturing element is composed of contact image sensors (CIS). Here not only can the contact image sensors be switched off individually, it is also possible to switch off individual channels of contact image sensors in order to restrict the data quantity in as optimum a manner as possible.

The object on which the invention is based is achieved in terms of the method in that a width of the document is detected when the document is initially placed in the large-format scanner, that, depending on the detected width, regions of at least one image-capturing element that are not required because they do not confront the document are switched off to reduce the bandwidth of the scanned data, that the document is scanned, that the scanned data is transferred via the standard interface, that the maximum transferrable data quantity is continuously monitored during the data transfer and that the speed of the document feed is adjusted depending on the monitoring result.

Already during initial placement of the document, its width is detected and the unneeded regions of the image-capturing element detecting the entire width of the large-format scanner are switched off. Thus no data is scanned in those regions in which no document is recognized, so that from the start essentially only data is scanned that actually belong to the document. That is, all of the data is not detected over the entire width of the scan lines and transferred to the computer, as is otherwise usual. This means that the data quantity is regularly reduced. Of course, if the document format is known, it can be possible to switch off some sections of the image-capturing element likewise via the input of the document format. Before the actual scan process, the actual data quantity is determined at the same time as switching off the image-capturing elements, and the feed rate for the document is calculated from this data quantity and depending on the determined maximum transferrable data quantity.

It has proven useful that the maximum transmission bandwidth of the standard interface is determined before the scan start, preferably automatically, and the result is used for presetting the speed of the document feed.

That is, when switching on the scanner and the PC, what quantities of data can be transferred as a maximum via the interface are determined. According to the maximum transferrable data and knowing the document width, the scanning speed with which the data is recorded can be calculated so that, for example, the recorded data quantity does not exceed the bandwidth of the data simultaneously transferred to the PC due to excessively high scan speeds, and that a scanning speed that is too low, which would render the large-format scanner ineffective, is not set either.

It has proven to be useful that the width detection is carried out as a rough width detection by the photoelectric curtain.

It is advantageous that, depending on the width detection, regions of the image-capturing element that are not required are switched off before the scan process is started.

Through the ability to switch off individual regions of the image-capturing element, it is possible for the total width of the image-capturing element to be adapted in the best possible manner to the detected document width, so that in fact only that data is recorded that comes from the document. Regions outside the document, in contrast to the prior art, are essentially not scanned at all, so that no data is collected here.

It is advantageous that black/white calibration data is applied to the scanned data during the scan process. It is also advantageous that the scanned data is corrected.

It has also proven to be useful to compress the scanned data and then transfer it via the standard interface in the compressed state. Thus more data can be transferred via the interface so that more data can be recorded and the speed of the large-format scanner is increased.

It has proven to be useful when compression is carried out losslessly in real time.

The data transfer is preferably monitored continuously and the speed of the scanner is corrected depending on the monitoring result.

Due to the other uses of the PC, the maximum bandwidth of the data to be transferred can change. With appropriate correction, the scan speed can be adapted to the changing bandwidth. This can go so far that the document feed is stopped and is started again at a lower speed.

According to the invention the data is decompressed and stored in the PC.

Advantageously, the scanned or stored data is refined using filters and are outputted in this refined form or stored in the desired target format.

### BRIEF DESCRIPTION OF THE DRAWING

The invention is explained in more detail with reference to a drawing. The FIGURE thereof is a flow chart showing the individual process steps.

### SPECIFIC DESCRIPTION OF THE INVENTION

First, the original document is inserted at 1. The width detection is carried out at 2, for example rough width detection via photoelectric curtain as a document feeder advances the document in a travel direction with the width of the document extending transverse to the travel direction. Depending on the width recognition 2 detected by a device upstream of a bar-type imaging element extending transversely across the document path downstream of the width-detection device, regions of the image-capturing elements, in this case CIS elements or individual channels of the CIS elements, not needed are switched off at 3. At the same time scan speed is determined at 4, depending on width detection 2 and the data quantity to be expected given the document width. This calculation includes furthermore data such as resolution, color mode 5 and the determination of the bandwidth 6. Now the scan start 7 takes place.

Correction data, such as black/white calibration data, are applied to the data determined in the scan process at 8. The correspondingly corrected scanned data is compressed in a lossless manner at 9. Thereafter data transfer 10 takes place via standard interfaces such as for example USB/2 or gigabit-LAN interfaces. Lossless data decompression 12 takes place in a PC 11. This is followed by a processing 13 of the scanned data, for example the brightness, the sharpness, the stitching, etc. are refined using filters. The data processed in this manner are stored at 14.

The number of image sensors that will not confront the document being scanned and that are turned off reduces the bandwidth of the data output of the imaging sensor, so the document feeder can increase feed speed of a narrow document without exceeding the maximum bandwidth of the interface connecting the scanner to the PC. Only a document of maximum width, corresponding to the full length of the imaging element so that all its sensors will be left on, moves at the minimal feed speed.

We claim:

1. A method of operating a large-format scanner having
means for feeding a document along a document feed path in a predetermined longitudinal direction at a feed speed with a width of the document extending transverse to the direction,
an image-capturing element comprised of a row extending transversely across the path of image sensors such that a data output of the element has a bandwidth determined by the number of sensors in the row and the feed speed, and
a standard interface of predetermined maximum transmission bandwidth connected to the element and connectable to a computer to feed outputs of the sensors of the element to the computer,
the method comprising the steps of:
providing a device in the scanner along the document feed path longitudinally upstream of the image-capturing element and using the device for detecting a width of a document moving along the path;
employing sensors in the element that can be turned on and off individually;
employing a document-feeding means of variable speed;
on movement of the document in the direction past the device by the document-feeding means, determining a width transverse to the feed direction of the document; and
before the document reaches the element, based on the detected width of the document, switching off those sensors of the image-capturing element that will not confront the document when it longitudinally passes the image-capturing element and setting the feed speed of the document as it moves past the element such that documents of great width move more slowly past the element than documents of narrow width and the bandwidth of the output is generally equal to the maximum transmission bandwidth of the interface.

2. The method according to claim 1, wherein the width detection is carried out as a rough width detection by a photoelectric curtain.

3. The method according to claim 1, further comprising the step of:
applying black/white calibration data to the scan data during the scan process.

4. The method according to claim 1, further comprising the step of:
correcting the scan data before transfer via the standard interface.

5. The method according to claim 1, further comprising the step of:
compressing the scanned data.

6. The method according to claim 5, wherein the compression is carried out losslessly and in real time.

7. The method according to claim 1, further comprising the steps of:
monitoring data transfer via the standard interface continuously and
correcting the document feed rate depending on a result of the monitoring.

8. The method according to claim 1, further comprising the step of:
compressing and storing the data in the PC.

9. The method according to claim 8, further comprising the steps of:
refining the scan data using filters and
reading out or storing the refined data in a desired target format.

10. In a large-format document scanner having
means for feeding a document along a document feed path in a predetermined longitudinal direction at a feed speed with a width of the document extending transverse to the direction,
an image-capturing element comprised of a row extending transversely across the path of image sensors such that a data output of the element has a bandwidth determined by the number of sensors in the row and the feed speed, and
a standard interface of predetermined maximum transmission bandwidth connected to the element and connectable to a computer to feed outputs of the sensors of the element to the computer,
the improvement wherein:
the document-feeding means is of variable speed;
the sensors of the image-capturing element can be turned on and off individually;
a device is provided in the scanner along the document feed path longitudinally upstream of the image capturing element for detecting a width of a document moving along the path upstream of the element; and
control means is provided connected to the document-feeding means and to the image-capturing element for, before the document reaches the element,
based on the width of the document detected by the device, switching off those sensors of the image-capturing element that will not confront the document when it longitudinally passes the image-capturing element, and
setting the feed speed of the document as it moves past the element such that documents of great width move more slowly past the element than documents of narrow width and the bandwidth of the output of the element is generally equal to the maximum transmission bandwidth of the interface.

11. The apparatus according to claim 10, wherein the device for detecting the width of the document is a photoelectric curtain.

12. The apparatus according to claim 11, wherein image-capturing elements of the photoelectric curtain at least on one side of a center of the document path are set at spacings that decrease.

13. The apparatus according to claim 11, wherein the image sensors are contact image sensors.
